(19) United States
(12) Patent Application Publication
(10) Pub. No.: US 2026/0140044 A1
(43) Pub. Date: May 21, 2026

(54) Laboratory Analyser Unit

(71) Applicant: HACH LANGE GMBH, Berlin (DE)

(72) Inventors: Carsten Schulz, Berlin (DE); Clemens Hanschke, Berlin (DE)

(21) Appl. No.: 18/706,204

(22) PCT Filed: Oct. 26, 2022
(86) PCT No.: PCT/EP2022/079959

§ 371 Date: Apr. 30, 2024

(30) Foreign Application Priority Data
Nov. 4, 2021 (DE) 10 2021 128 699.9

(51) Int. Cl. G01N 21/31; G01J 5/00; G01N 21/78; G01N 35/00; G01N 35/02; G01N 35/04

(52) U.S. Cl. CPC G01N 21/31; G01J 5/00; G01N 21/78; G01N 35/025; G01N 2035/00752; G01N 2035/0406; G01N 2035/0441; G01N 2201/1211

(57) ABSTRACT

A laboratory analyser unit (10) for determining an analyte of a liquid sample (48) mixed with a reagent and contained in a sample cuvette (40) which comprises a thermal radiation measuring field (46) on the outside, comprising an analyser (12) for determining an analyte concentration of the liquid sample (48) in the sample cuvette (40), a pyrometer (50) for determining the surface temperature of the measuring field (46) wherein the pyrometer (50) is arranged in such a way that a detection cone (52) of the pyrometer (50) is aligned with the measurement field (46) of the sample cuvette (40) inserted into the analyser unit (10), and an analyser control unit (20), which is signal-connected to the analyser (12) and which comprises a temperature evaluation module (22) which is signal-connected to the pyrometer (50) and which evaluates the sample cuvette temperature (T) determined by the pyrometer (50). The invention allows a simple temperature detection of the sample temperature.

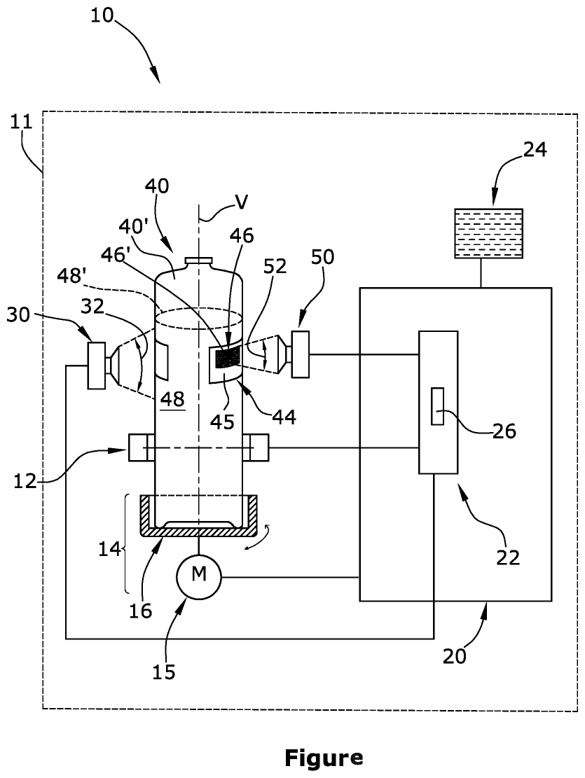

The invention refers to a laboratory analyser unit for determining an analyte of a liquid sample mixed with a reagent, which sample is contained in a sample cuvette.

The sample cuvette is a sample container which is usually provided ready-to-use by the manufacturer for the determination of a specific analyte or parameter of a liquid sample. The solid or liquid reagent is therefore usually already inserted into the respective sample cuvette by the manufacturer. For sample preparation, a defined volume of the liquid sample is manually pipetted into the sample cuvette already filled with the reagent using a suitable laboratory pipette.

After the reagent has reacted completely with the analyte of the liquid sample, the sample cuvette is inserted into the laboratory analyser unit and the analyte or the relevant parameter is determined quantitatively with an analyser that usually works photometrically.

A laboratory analyser unit is known, for example, from EP 3 249 386A1 . Typical parameters to be determined in water analysis are the chemical oxygen demand, the ammonium or the nitrate content. The problem here is that the reaction of the respective reagent with the analyte, which changes the colour for example, can be temperature-dependent. In a laboratory analyser unit, an ambient temperature of 20° C. is assumed, so that a temperature of the liquid sample in the sample cuvette of 20° C. is also assumed when quantitatively evaluating the analyser reading. However, the error in an ammonium determination or in the determination of the chemical oxygen demand is already 20% at a liquid sample temperature of 15° C. instead of 20° C., which is not acceptable and must therefore be corrected by manually entering the liquid sample temperature.

Therefore, the object of the invention is to provide a laboratory analyser unit with simplified temperature compensation of the liquid sample temperature.

This object is solved according to the present invention by a laboratory analyser unit with the features of claim 1.

The laboratory analyser unit according to the present invention is used for determining a parameter or an analyte of a liquid sample mixed and reacting with a reagent, which sample is contained in a sample cuvette which is usually a glass body. In the present case, a parameter or analyte is basically any chemical or physical parameter of the liquid sample, for example the chemical oxygen demand, the ammonium or the nitrate content, or any other parameter, and in particular any typical parameter of water analysis.

The laboratory analyser unit comprises a physical analyser for determining an analyte concentration of the liquid sample in the sample cuvette. The analyser is preferably a photometer which determines the transmission or absorption of the sample cuvette including the liquid sample having reacted with the reagent at a specific wavelength or at several specific wavelengths transmissively or reflectively.

Laboratory analyser units are used, among others, at sewage treatment plants for quality control, so that the liquid sample can usually have the outside temperature when it is pipetted into the sample cuvette. Obviously, the sample cuvette itself can also have the outside temperature and the laboratory analyser unit can in principle also be used outside of a heated or constantly tempered laboratory room. The temperature of the liquid sample in the sample cuvette can therefore deviate by up to 20 Kelvin from the reference temperature of usually 20° C. for which the calibration curves for evaluating the analyser measurement results are created by the manufacturer.

The sample cuvette comprises a thermal radiation measuring field on or at the cuvette outside, which field always has a specific colour or colouring. The analyser unit comprises a pyrometer for determining the surface temperature of the measuring field. The pyrometer is configured in particular for a measuring range of 0° C. to 40° C., and is usually a band radiation pyrometer, for example a thermal or pyroelectric sensor.

The pyrometer is arranged in such a way that, for temperature determination, a detection cone of the pyrometer is aligned with the thermal radiation measuring field of the sample cuvette inserted into the laboratory analyser unit. In this way, the temperature of the cuvette body of the sample cuvette can be determined with a certain accuracy. It is basically assumed that the cuvette body has approximately the same temperature as the liquid sample in the sample cuvette. In this way, the temperature of the liquid sample in the sample cuvette can be approximately determined. In any case, larger deviations from the reference temperature of, for example, 20° C. can be reliably determined.

The laboratory analyser unit comprises a control unit which is signal-connected to the analyser and which comprises a temperature evaluation module which is signal-connected to the pyrometer and which evaluates the cuvette temperature determined by the pyrometer. In the present case, an evaluation can be understood as any useful evaluation, for example the output of a correction factor, the output of a block signal and/or the output of a release signal. In the simplest case, the temperature evaluation module determines the deviation from a reference temperature, for example 20° C., and outputs a corresponding evaluation signal depending on the deviation from the reference temperature.

The application of a thermal radiation measuring field on the sample cuvette, in particular on the outside of the cuvette body, can be realised simply and inexpensively, for example as a label which is applied to the outside of the cuvette body with the best possible thermal contact and the lowest possible thermal resistance to the cuvette body.

The thermal radiation measuring field is opaque and can have, for example, a certain and defined shade of grey or black, which should basically be the same for all sample cuvettes used, since the emissivity of the measuring field must be known. Since, for example, an infrared pyrometer can be provided with a corresponding converging lens and the distance between the pyrometer and the measuring field is always approximately the same, the measuring spot of the pyrometer can be relatively small, so that the corresponding measuring field on the sample cuvette can also be relatively small, but must be larger than the measuring spot.

In this way, a laboratory analyser unit is provided which automatically determines the temperature of the liquid sample in the sample cuvette with a certain degree of accuracy using relatively simple means.

Preferably, the laboratory analyser unit comprises a barcode camera, wherein the sample cuvette comprises an externally readable barcode which is readable by the barcode camera. The sample cuvette barcode can contain information in coded form about the type of test, i.e. about the parameter or analyte to be determined and the measuring range, and can also contain further information, for example batch-specific calibration curves and values, an expiry date, hazard warnings, etc. The barcode can be read by the barcode camera. More preferably, the barcode is a two-dimensional barcode in which a large amount of information is stored.

In particular, the barcode can also contain temperature limit values and/or temperature-dependent or temperature-related correction values, which are transmitted to the temperature evaluation module and can be included in the evaluation of the sample cuvette temperature determined by the pyrometer.

Preferably, the barcode is black and white and the thermal radiation measuring field is defined by the barcode. A two-dimensional barcode always comprises the same shade of grey when viewed as a whole, since the black and white pixels each comprise approximately 50%. When using the two-dimensional barcode as a measuring field, a separate measuring field is therefore not necessary.

Preferably, the laboratory analyser unit comprises a cuvette platform rotating device that rotates the sample cuvette about its vertical axis, which cuvette is standing upright on a rotary platform and is essentially hollow cylindrical. The sample cuvette rotary platform is a standard feature in a typical laboratory analyser unit, in particular in a laboratory analyser unit that comprises as an analyser a photometer that determines the transmission or absorption horizontally and radially through the cylindrical sample cuvette at one or more specified wavelengths.

During photometry, the sample cuvette is rotated by the cuvette platform rotating device, so that in this way an average photometric transmission or absorbance value for the liquid sample in the sample cuvette can be obtained, and local artefacts and local differences in analyte concentration have no relevant negative influence on the accuracy. The cuvette platform rotating device is further used to rotationally align the measuring field, which is placed on the outer circumference of the sample cuvette at a specific location, with the pyrometer fixedly mounted in the laboratory analyser unit in such a way that the detection cone of the pyrometer sees only the measuring field. Further, the cuvette platform rotating device is optionally used to rotationally align the barcode with the barcode camera such that the barcode camera sees and can read the barcode at a different moment or at the same moment.

Preferably, the laboratory analyser unit comprises a display connected to the analyser control unit, wherein the analyser control unit, after a measurement of the cuvette temperature, causes the evaluation made by the temperature evaluation module to be displayed on the display. In particular, the display can be used in this way to indicate a release or a blocking of the further analysis process.

In the following, an embodiment of the invention will be explained in more detail with reference to the FIGURE. The FIGURE schematically shows a laboratory analyser unit including an inserted sample cuvette.

The FIGURE schematically shows a photometric laboratory analyser unit 10, with which a parameter or an analyte of a liquid sample 48 in a sample cuvette 40 is quantitatively determined.

The laboratory analyser unit 10 comprises, in a unit housing 11, a cuvette platform rotating device 14 which essentially comprises a rotary platform 16 rotatable about a vertical axis V and a rotary platform drive motor 15 which can cause the rotary platform 16 to rotate in one or both directions of rotation. For quantitative determination of the parameter or the analyte, the sample cuvette 40 filled with a reagent and a liquid sample is inserted into the laboratory analyser unit 10 and placed on the cuvette rotary platform 16.

The sample cuvette 40 consists of an optically transparent and essentially hollow cylindrical glass cuvette body 40′, which is already filled with a solid reagent by the manufacturer. The sample preparation is usually carried out outside the laboratory analyser unit 10 by manually pipetting a prescribed volume of a liquid sample into the sample cuvette 40. Typical parameters or analytes to be determined in water analysis are the chemical oxygen demand, the ammonium or the nitrate content.

The sample cuvette 40 is inserted into the laboratory analyser unit 10 to determine the analyte concentration so that it stands vertically on the cuvette rotary platform 16.

The sample cuvette 40 comprises on the outside an information carrier 44 which is an opaque, non-transparent paper or plastic label 45 on which an optical cuvette identification is applied as a two-dimensional barcode 46′. The two-dimensional barcode 46′ defines a grey thermal radiation measuring field 46. Alternatively, the thermal radiation measuring field may be provided separately from the barcode 46′ on the label 45.

The horizontal boundary layer 48′ between the liquid sample and air is vertically above the measuring field 46, which is checked by a suitable device, for example by a scale or an optical device of the analyser unit. This ensures that the thermal radiation measuring field 46 roughly has the temperature of the liquid sample 48.

Vertically above the rotary platform 16 and below the cuvette information carrier 44 of the inserted sample cuvette 40, the laboratory analyser unit 10 comprises a photometric analyser 12 which in the present case operates transmissively and which determines the transmission or absorption of the sample cuvette 40 filled with the liquid sample 48 at one or more specific wavelengths.

Vertically above the analyser 12, the laboratory analyser unit 10 comprises a radially oriented barcode camera 30 with a relatively large aperture angle 32. The barcode camera 30 takes a 2-dimensional image, so in the present case it is not a line camera, and is focused approximately at the radial distance from the cuvette body 40′.

The laboratory analyser unit 10 comprises, at the vertical height of the barcode camera 30, a pyrometer 50 which is also radially oriented and which is directed with its relatively small detection cone 52 towards the information carrier label 45. When the measuring field 46 is precisely rotationally aligned with the pyrometer 50, the measuring spot of the pyrometer 50 is entirely within the rectangular or square measuring field 46 defined by the barcode 46′.

The laboratory analyser unit 10 comprises an electronic and program-controlled control unit 20 which is informationally connected to the cuvette platform rotating device 14, the analyser 12, the pyrometer 50 and the barcode camera 30 via corresponding signal connections. Further, the laboratory analyser unit 10 comprises a display screen 24.

The instrument control unit 20 comprises a temperature evaluation module 22, which is connected to the pyrometer 50 via a signal connection, and which evaluates the cuvette temperature T determined by the pyrometer 50. A temperature value storage 26 is assigned to the temperature evaluation module 22, in which a reference temperature, temperature limit values as well as temperature correction factors are stored.

The so-called sample preparation is usually carried out outside the laboratory analyser unit 10: the sample cuvette 40 already filled with a solid reagent by the manufacturer is opened and a defined volume of a liquid sample 48 is pipetted into the sample cuvette 40. The defined volume of the liquid sample 48 is so large that the liquid boundary layer 48′ lies above the measuring field 46. Once the pipetted sample liquid 48 has reacted with the reagent, the sample cuvette 40 is inserted into the laboratory analyser unit 10 by placing the sample cuvette 40 on the rotary platform 16.

The sample cuvette 40 is then rotated by the rotating device 14 until the measuring field 46, which is a barcode 46′, is precisely rotationally aligned with the pyrometer 50 so that the measuring spot of the pyrometer 50 lies entirely within the thermal radiation measuring field 46. A temperature measurement is then provided by the pyrometer 50, and the measured cuvette temperature T is stored in the temperature value storage 26.

Furthermore, the correct position of the boundary layer 48″ above the thermal radiation measuring field 46 is automatically checked by the apparatus.

Subsequently, the sample cuvette 40 is rotated by the rotating device 14 until the barcode 46′is rotationally aligned with the camera 30, which then reads the barcode 46′. From the read barcode 46′, the device control unit 20 takes the particular determination parameter, for example the chemical oxygen demand, if applicable the permissible measuring range, the shelf life, calibration data and in particular the reference temperature values TS, the upper temperature limit value, the lower temperature limit value as well as temperature correction factors for the particular determination parameter. Said values and correction factors are stored in the temperature value storage 26.

Finally, the temperature evaluation module 22 first determines whether the measured cuvette temperature T is within the two temperature limit values. If this is not the case, the analysis process is stopped, an appropriate block signal is output, and corresponding information is shown on the display 24. If the measured cuvette temperature T is within the two temperature limit values, the deviation of the cuvette temperature T from the stored reference temperature value TS is determined. If the measured cuvette temperature T is not within the temperature limit values, the analysis process is stopped, a corresponding block signal is output and corresponding information is displayed on the display 24. If the deviation is more than 2.0 Kelvin, for example, a correction factor K is determined for the correction of the analyser measured value. In the event of a deviation of, for example, less than 2.0 Kelvin, a release signal is generated and the analysis process is continued without further action. This is communicated with a corresponding message on the display 24.

Simultaneously or subsequently, an absorbance or transmittance reading is integratively determined by the analyser 12, the cuvette 40 being continuously rotated by the rotating device 14 for this purpose. The result of this raw absorbance or transmission determination is corrected by the control unit 20, if necessary, with the correction factor K, so that a corrected and more accurate absorbance or transmission value is obtained, and from this finally an accurate parameter value or concentration value is obtained for the parameter or analyte in question.

1-7. (canceled)

8. A laboratory analyser unit for determining an analyte of a reagent-mixed liquid sample contained in a sample cuvette which comprises a thermal radiation measuring field on the outside, the analyser unit comprising:
an analyser for determining an analyte concentration of the liquid sample in the sample cuvette;
a pyrometer for determining the surface temperature of the measurement field, the pyrometer being arranged in such a way that a detection cone of the pyrometer is aligned with the measurement field of the sample cuvette inserted into the analyser unit; and
a control unit which is signal-connected to the analyser and comprises a temperature evaluation module which is signal-connected to the pyrometer and evaluates a sample cuvette temperature detected by the pyrometer.

9. The laboratory analyser unit according to claim 8, further comprising a barcode camera, wherein the sample cuvette comprises an externally readable barcode readable by the barcode camera.

10. The laboratory analyser unit according to claim 9, wherein the barcode is black and white and the thermal radiation measurement field is defined by the barcode.

11. The laboratory analyser unit according to claim 9, wherein the barcode is a two-dimensional barcode.

12. The laboratory analyser unit according to claim 8, further comprising a cuvette platform rotating device which rotates the sample cuvette standing on a rotary platform about its vertical axis.

13. The laboratory analyser unit according to claim 8, wherein the analyser is a photometer.

14. The laboratory analyser unit according to claim 8, further comprising a display connected to the control unit, wherein the control unit, after a measurement of the cuvette temperature, initiates a presentation at the display of the evaluation made by the temperature evaluation module.
